(19) United States
(12) Patent Application Publication
(10) Pub. No.: US 2003/0237078 A1
(43) Pub. Date: Dec. 25, 2003

(54) Incorporating simulation analysis instrumentation into HDL models

(75) Inventors: Derek Edward Williams, Austin, TX (US); Wolfgang Roesner, Austin, TX (US)

Correspondence Address: BRACEWELL & PATTERSON, L.L.P., Intellectual Property Law, P.O. Box 969, Austin, TX, 78767-0969, US

(73) Assignee: International Business Machines Corporation

(21) Appl. No.: 10/177,844

(22) Filed: Jun. 20, 2002

(51) Int. Cl. G06F 9/45

(52) U.S. Cl. 717/155

(57) ABSTRACT

A method, system, and program product for implementing simulation analysis instrumentation within a hardware description language (HDL) model. In accordance with the method of the present invention, one or more source code HDL design entities that simulate circuit functionality within the HDL model are compiled into one or more corresponding design entity objects. One or more source code instrumentation modules are compiled into one or more corresponding instrumentation objects. Each of the instrumentation objects is a single irreducible intermediate object code primitive that invokes a simulation analysis function in which simulation data is processed over a simulation testcase. An object code file containing the one or more design entity objects and the one or more instrumentation objects are post-compile processed to generate an executable simulation model.

### BACKGROUND OF THE INVENTION

1. Technical Field

The present invention relates in general to simulation modeling of circuit designs using hardware description languages (HDLs). In particular, the present invention relates to incorporating instrumentation within an HDL model to enhance model verification and testing processes. More particularly, the present invention relates to simulation analysis instrumentation modules that are deployed during compilation and post-compilation processing of an HDL model.

2. Description of the Related Art

As the complexity of an integrated circuit design increases, so does the difficulty of ensuring the “correctness” of the design. Modern simulation tools aid considerably in verifying the overall functionality of a digital integrated circuit, but monitoring the internal behavior of a design is considerably more complicated. Hardware description languages (HDLs) such as VHDL and Verilog are utilized to describe a digital electronic system at various levels of abstraction. Regardless of the level of abstraction described, an HDL ultimately provides either a behavioral or direct definition of constituent hardware components such as transistors, logic gates, memory devices, etc., as embodied by HDL “design entities”, which are the fundamental operative components of an HDL model.

An entity declaration is utilized in an HDL source code file to name and describe the input/output ports of a given design entity. FIG. 1 illustrates a portion of an exemplary HDL source code file containing an entity declaration 102 for a simple register. The architectural implementation and individual behavior of the object design entity is set forth in a body section 104. As depicted in FIG. 1, the behavior of the entity includes process statements, each containing sequential statements which include signal assignment and wait statements. Specifically, the architectural behavior of reg1 is set forth in body section 104 including a process description of storing multiple bit type inputs via input ports d0, d1, and d2 when enable, en, and clock, clk, are simultaneously asserted to a logic 1. The behavioral definition continues with the stored bits being output from output ports q0, q1, and q2 after the bits have been input.

The reg1 design entity may be singly or multiply instantiated within an overall simulation model which typically includes a vast number of other hardware design entities. During simulation model test execution, determining the combined behavior of higher-level design entities in which reg1 and other individually behaviorally defined entities are instantiated presents considerable challenges for very complex simulation models.

One approach to addressing the need to monitor intermediate simulation data involves writing verification programs at the simulation phase of the design process that are designed to monitor, during the course of a simulation run, correctness characteristics and intermediate results. These verification programs are typically written in general-purpose high level programming languages such as C or C++, which provide greater programming flexibility than circuit design languages such as HDLs. Such general-purpose high level languages typically provide greater expressiveness than HDL languages, thereby facilitating the efficiency with which complex checking programs may be developed. A problem associated with this method, however, is that it adds further complexity to the simulation process by requiring an extra communication step between designers who design the circuit using HDLs, and simulation programmers who develop simulation checking/verification programs using general-purpose high level languages such as C or C++. The efficiency and effectiveness of the simulation testing are therefore reduced.

An alternate solution to obtaining simulation model behavioral data is to instantiate specialized “instrumentation” logic using the native semantics of the object HDL during the HDL source code development stage. Such an approach is described by U.S. Pat. No. 6,195,627, issued to Bargh et al. on Feb. 27, 2001. The HDL-centric model instrumentation technique taught by U.S. Pat. No. 6,195,627 is based on an altered HDL source code syntax that is utilized to incorporate HDL instrumentation during simulation testing without the instrumentation necessarily becoming a part of the compiled version of the model. As explained therein, such HDL-based instrumentation is useful for detecting and recording occurrences of simulation testing “events” such as fail events, count events, and testcase harvest events. The approach taught by U.S. Pat. No. 6,195,627 utilizes instrumentation entities having relatively simple hardware-based (i.e. logic gate) functionality and is therefore effective for internally tracking occurrences of singular simulation events without unduly increasing the processing overhead required to incorporate the instrumentation logic within the model during a simulation run.

In addition to detecting occurrences of a specified simulation event, it would further be useful to provide a more sophisticated class of instrumentation capable of internally processing and analyzing model behavior. Examples of such analytic instrumentation include many potentially useful statistical functions such as max/min functions, average/normalization functions, and comprehensive statistical computation and presentation functions such as histrograms.

Such analytic instrumentation may be deployed by the use of HDL-based instrumentation such as that described by U.S. Pat. No. 6,195,627. However, the nature of an HDL as a hardware component/device emulation tool, makes conventional HDL descriptions an unsuitable platform for deploying higher-level instrumentation within a simulation model. Referring to FIG. 3A, for example, there is depicted a logic diagram of a design entity CKT 302 as described by an HDL source code file. CKT 302 includes five instantiated sub-entities including three latches, L1 304, L2 306, and L3 312, an OR gate G1 308, and an AND gate G2 310. As shown in FIG. 3A, HDL source code design entities (such as reg1 in FIG. 1) simulate circuit functionality, i.e. components and devices that may be implemented in a physical circuit layout.

FIG. 3B is a block diagram representation of an intermediate level object code database 325 containing a compiled version of design entity CKT 302. Object code database 325 includes intermediate level objects L1 322, L2 326, and L3 330, corresponding to source code latches 304, 306, and 312, respectively. Object code database 325 further includes intermediate level objects G1 324 and G2 328 corresponding to source code gates G1 308 and G2 310, respectively. Each of intermediate objects L1 322, G1 324, L2 326, G2 328, and L3 330 is an irreducible object code primitive that is discretely processed by an HDL model build tool to generate a corresponding instruction set representation, such as instruction set representation 350 in FIG. 3C. Instruction set representation 350 includes load, store, and logic operators (OR and AND) which implement a software simulation of the described functionality of the intermediate level objects within object code database 325.

As utilized herein, “simulation analysis instrumentation” refers to program instruction means for collecting and processing simulation data over the entirety of the simulation testcase. Utilizing conventional HDL source code and object code primitives such as those depicted in FIG. 3 to deploy simulation analysis instrumentation within an HDL model requires considerable programming and processing overhead since the cycle-based instrumentation functionality often does not map efficiently to gate-level representations. Furthermore, since the instrumentation is not intrinsic to the actual circuit design, generating and processing a gate-level representation of such instrumentation is inefficient.

From the foregoing, it can be appreciated that a need exists for implementing simulation analysis instrumentation within an HDL model that may be flexibly incorporated within an executable model without the hardware interface overhead inherent in HDL entity descriptions. The present invention addresses such a need.

### SUMMARY OF THE INVENTION

A method, system, and program product for implementing simulation analysis instrumentation within a hardware description language (HDL) model are disclosed herein. In accordance with the method of the present invention, one or more source code HDL design entities that simulate circuit functionality within the HDL model are compiled into one or more corresponding design entity objects. One or more source code instrumentation modules are compiled into one or more corresponding instrumentation objects. Each of the instrumentation objects is a single irreducible intermediate object code primitive that invokes a simulation analysis function in which simulation data is processed over a simulation testcase. An object code file containing the one or more design entity objects and the one or more instrumentation objects are post-compile processed to generate an executable simulation model.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates a conventional HDL source code design entity;

FIG. 2 is a high-level block diagram depicting a model compilation and assembly system flow in accordance with a preferred embodiment of the present invention;

FIG. 3A illustrates a logic diagram of a design entity as described by a conventional HDL source code file;

FIG. 3B is a block diagram representation of an intermediate level object code database containing a compiled HDL design entity;

FIG. 3C depicts an instruction set representation of the contents of the intermediate level object code database shown in FIG. 3B;

FIG. 4 is a high-level block diagram illustrating a model build structure in accordance with a preferred embodiment of the present invention;

FIG. 5 is a flow diagram depicting process steps performed during non-hardware based instrumentation assimilation in accordance with a preferred embodiment of the present invention;

FIG. 6 is a logic diagram representing an HDL design entity containing multiple intermediate level objects that implements a Max function;

FIG. 7A is a block diagram representation of an instrumentation object that provides a non-hardware based implementation of a Max function in accordance with one embodiment of the present invention; and

FIG. 7B depicts an instruction set translation of the instrumentation object illustrated in FIG. 7A.

### DETAILED DESCRIPTION OF THE PREFERRED EMBODIMENT

This invention is described in a preferred embodiment in the following description with reference to the figures. While this invention is described in terms of the best mode for achieving this invention's objectives, it will be appreciated by those skilled in the art that variations may be accomplished in view of these teachings without deviating from the spirit or scope of the present invention.

As explained in further detail with reference to the figures, the present invention is directed to implementing simulation analysis instrumentation within a hardware description language (HDL) model. It should be noted that the specific embodiments are presented as a preferred mode of implementation and should not be construed as limitations on the fundamental inventive principles set forth in the claims.

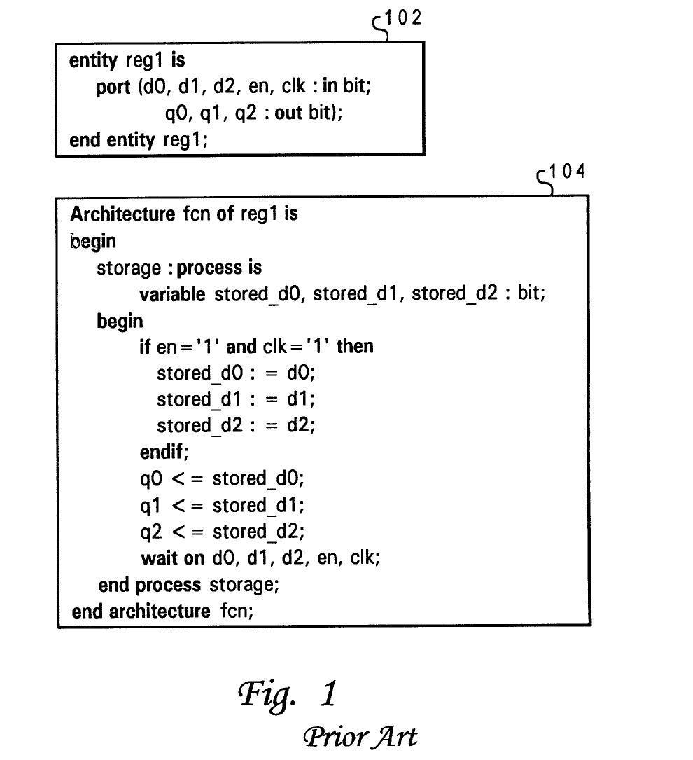

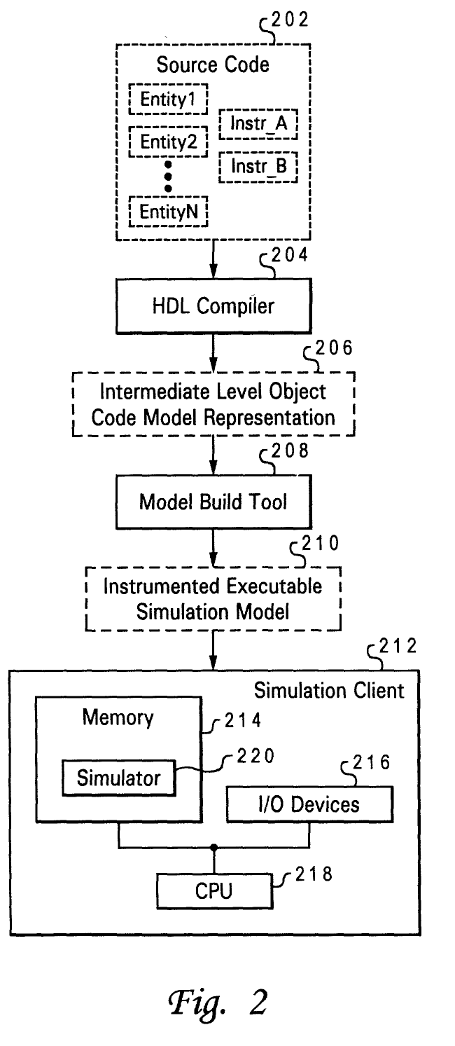

With reference now to the figures, and in particular with reference to FIG. 2, there is illustrated a high-level block diagram depicting a model compilation flow in accordance with a preferred embodiment of the present invention. Specifically, FIG. 2 depicts a first processing stage in which an HDL source code program 202 is processed by a compiler 204 to generate an intermediate level object code representation within an object code database 206. Source code program 202 includes a set of HDL design entities, Entity1 through EntityN, and a pair of instrumentation modules Instr_A and Instr_B. The term “module” is applied herein to distinguish simulation analysis functionality from the circuit-based functionality encoded within HDL “design entities.” The HDL design entities within HDL source code program 202 follow semantic and syntactic HDL convention such as that depicted in FIG. 1 in which signal processing functionality is implemented by hardware simulated primitives (e.g. logic gates, latches, etc.). The instrumentation module within HDL source code program 202 preferably follow an alternate syntactic representation such as the unconventional comment convention described in U.S. Pat. No. 6,195,627, incorporated in its entirety herein by reference.

In contrast, each of instrumentation modules Instr_A and Instr_B are a source code invocation of a simulation analysis function. In an important feature of the present invention, instrumentation modules Instr_A and Instr_B directly implement a simulation analysis function in which simulation data is processed over a multiple cycle simulation testcase.

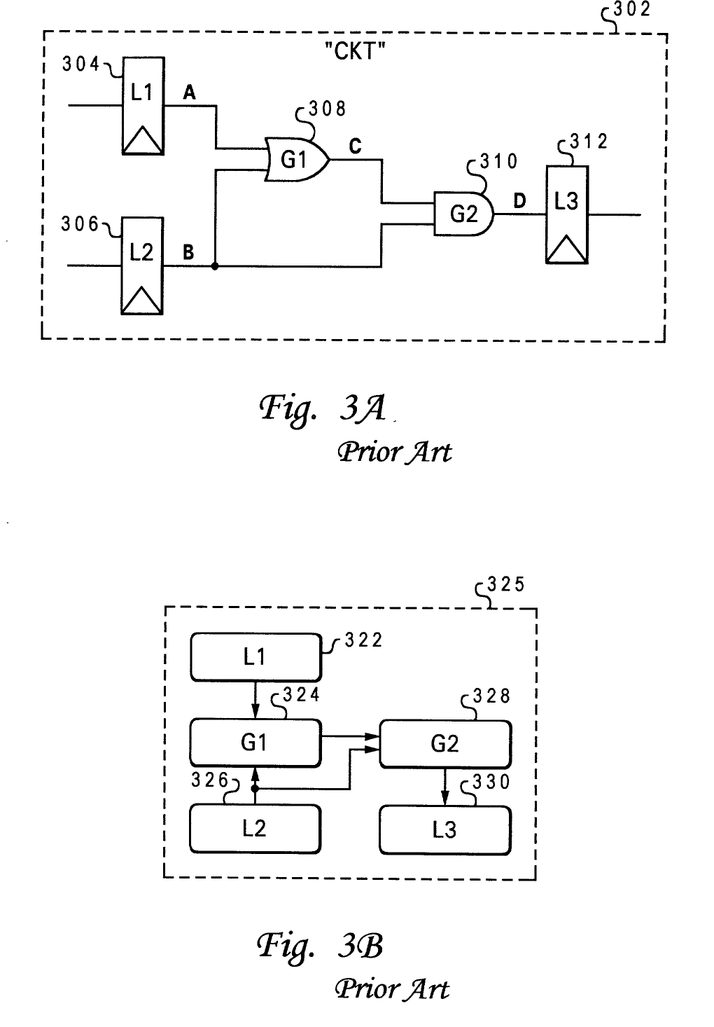

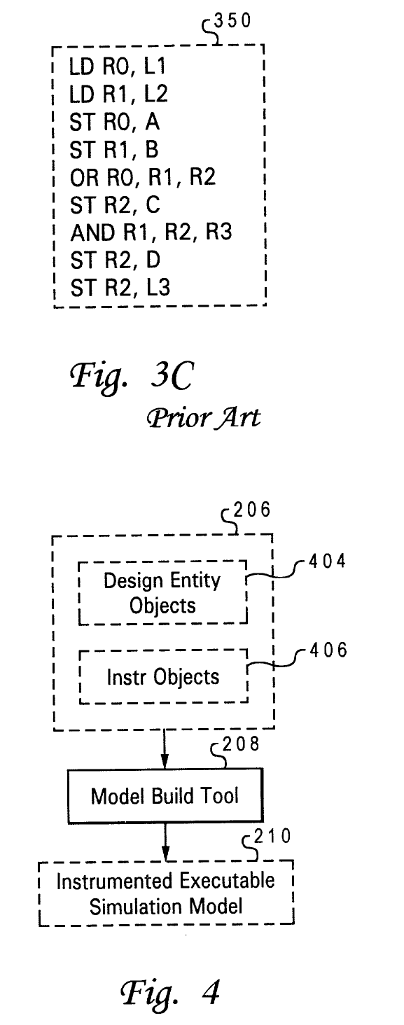

Compiler 204 performs compilation processing of the HDL design entity contents of HDL source code program 202 to generate multiple intermediate level design entity objects similar to the irreducible intermediate level objects illustrated in FIG. 3B. These intermediate level objects are included within the object code database 206 of the model, and correspond to the hardware components (e.g. logic gates, storage elements, etc.) represented by the source code HDL. In accordance with the depicted embodiment, compiler 204 also performs compilation processing of instrumentation module Instru_A to generate an instrumentation object within object code database 206 which is post-compile processed by a model build tool 208 to implement the simulation analysis functionality invoked by the corresponding source code. Compiler 204 also processes instrumentation module Instr_B to generate an instrumentation object within object code database 206 corresponding to the simulation analysis functionality invoked by the corresponding source code.

The functionality of the instrumentation modules may vary depending on design implementation and the particular simulation analysis desired for a given simulation test. For example, instrumentation module Instr_A may be designed to implement a “max” function for detecting a maximum value occurring at a particular bit field during a simulation testcase. In this case, the source code describing instrumentation module Instr_A invokes a single irreducible intermediate level object that, when assembled, comprises one or more instruction set instructions needed to determine the maximum value of the selected bit field during a simulation testcase.

A simulation analysis function, such as a max function, requires “memory” (i.e. the capacity to maintain a signal value) and processing means for maintaining and sequentially processing model data over the multiple cycles of a simulation testcase. The HDL constructs utilized to implement memory, typically latches, are distinct from the HDL constructs utilized for processing, such as logic gates. Therefore, utilizing HDL design entity constructs to invoke such simulation analysis functionality invariably requires multiple intermediate level objects that each correspond to a fundamental circuit design primitive such as a latch or a logic gate.

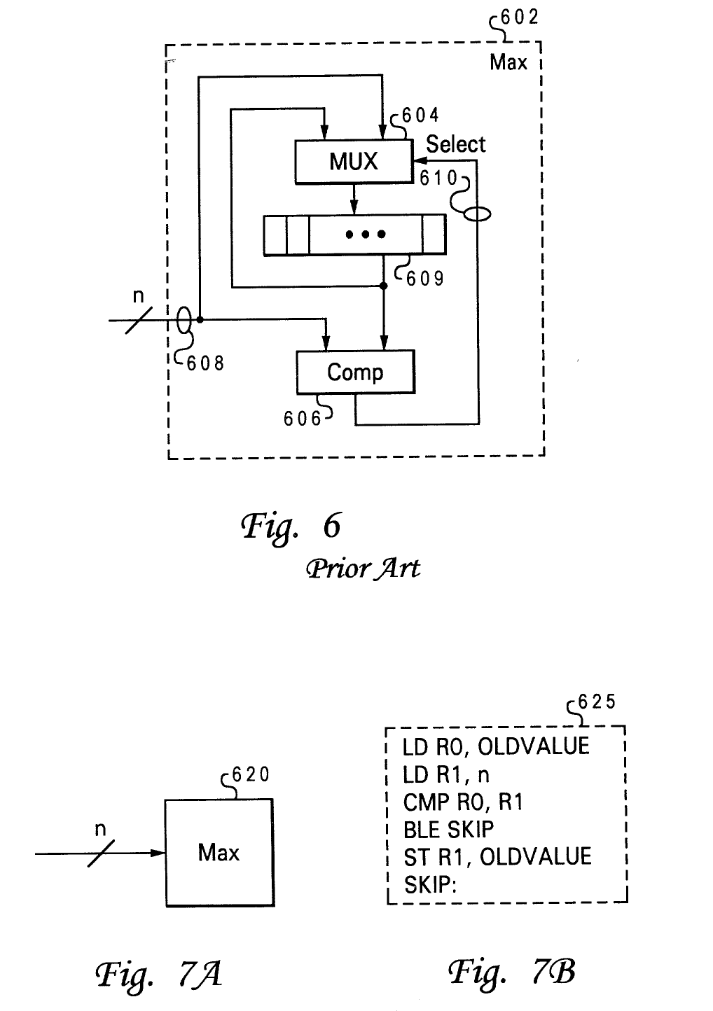

FIG. 6 illustrates the implementation of a max simulation analysis function utilizing conventional HDL design entity constructs. Specifically, FIG. 6 is a logic diagram representing an HDL design entity 602 containing multiple intermediate level objects that implements a max function. As shown in FIG. 6, the max function is implemented by HDL design entities corresponding to a register 609, a comparator 606, and a multiplexor 604. Register 609 holds a current maximum value as determined by comparator 606 which determines the greater of a next value from an n-bit input bus 608 and the current maximum value stored in register 609. The result of the comparison is utilized by multiplexor 604 to select between the next value on bus 608 and the current maximum value.

During compilation, HDL design entity 602 is reduced to multiple individual object level primitives similar to the breakdown depicted in FIG. 3B. The individual object level primitives are then individually post-compile processed to generate a set of instruction set instructions that provide a simulation of the hardware representation as embodied by the object level primitives. Although not depicted, it should be noted that the number of object level primitives required to implement a simulation analysis function, such as the max function implemented by HDL design entity 602, is typically considerable and greatly contributes to the overhead processing requirements for a given HDL model.

FIGS. 7A and 7B illustrate an instrumentation module primitive and corresponding instruction set implementation which provide a more efficient means of implementing simulation analysis functionality within an HDL model. In contrast to the psuedo hardware representation provided by HDL design entity 602 in which multiple data storage and processing logic primitives are required, the present invention employs irreducible object level primitives which map to a direct software implementation of the requisite simulation analysis functionality. FIG. 7A is a block diagram representation of an instrumentation object 620 that is invoked by compilation of a source code instrumentation module to provide a non-hardware based implementation of a max function within an HDL model. The box representing instrumentation object 620 corresponds to a single, irreducible intermediate object-level primitive that is processed as a discrete unit by model build tool 208 to generate a block of instruction set instructions 625 as shown in FIG. 7B. Instruction set instructions 625 implements a direct “software” (i.e. not representative of hardware functionality) implementation of an equivalent max function using two loads, one compare, one branch, and one store.

Returning to FIG. 2, Instr_A and Instr_B may be designed as max or min functions which determine the maximum or minimum value, respectively, of a particular bit field over a selected number of designated test cycles (typically the entire testcase). Other possible simulation analysis functions that may be effectuated by instrumentation modules Instr_A and Instr_B include averaging functions and data distribution functions, among others that are employed to generate histograms of simulation data. Although the specific processing result varies among simulation analysis instrumentation, the simulation analysis instrumentation of the present invention share two key characteristics. First, each instrumentation module is designed to process simulation data (i.e. signals generated during simulation testing of the object HDL model) over multiple cycles. Second, the simulation analysis functionality described for each source code instrumentation module is compiled into a single irreducible intermediate level object (i.e. an “instrumentation object”) by a compiler such as HDL compiler 204.

The intermediate level design entity objects and the instrumentation objects generated from the compilation of HDL source code program 202 are included within intermediate object code database 206 which is input into a model build tool 208 for post-compilation processing. As explained in further detail with reference to FIG. 4, model build tool 208 is augmented to recognize instrumentation objects having the aforementioned characteristics and to assimilate the instrumentation into an HDL model using instruction set instructions.

Model build tool 208 produces an instrumented executable simulation model 210 comprising design entity executables similar to those depicted in FIG. 3C and instrumentation executables similar to those depicted in FIG. 7B. Instrumented executable simulation model 210 is input for simulation testing and verification into a simulation client computer 212. As illustrated in FIG. 2, simulation client computer 212 includes a processor 218 having an instruction set architecture (not depicted) corresponding to the instruction set instructions utilized by model build to construct executable simulation model 210. Prior to simulation model test execution, instrumented executable simulation model 210 is loaded into a system memory 214 via an input/output interface 216. A simulation program 220, interchangeably referred to as a “software simulator”, is loaded into a system memory 214, and is executed during a simulation test with instrumented executable simulation model 210 received as input. During and/or after a simulation test run, simulation analysis results generated by the executable instruction set instructions corresponding to the simulation analysis function(s) encoded within the source code representation of instrumentation modules Instr_A and Instr_B are output in a user translatable format from I/O interface 216.

Referring to FIG. 4, there is depicted a high-level block diagram illustrating a model build structure employing model build tool 208 in accordance with a preferred embodiment of the present invention. The contents of intermediate object database 206 include design entity objects 404 (similar to the design entity objects depicted in FIG. 3B), and instrumentation objects 406 (similar to the max object depicted in FIG. 7A). With respect to FIG. 2, design entity objects 404 correspond to HDL design entities Entity1 through EntityN, while instrumentation objects 406 correspond to source code instrumentation modules Instr_A and Instr_B.

As depicted in FIG. 4, model build tool 208 performs post-compilation processing (e.g. linking, assembling, etc.) of intermediate object code database 206 to generate instrumented executable simulation model 210. The post-compilation processing of intermediate object code database 206 within model build tool 208 results in the generation of an executable model comprising machine language instructions corresponding to the instruction set architecture employed by simulation client computer 212. To this end, model build tool 208 includes program instruction means included within a conventional HDL assembler for identifying and matching each of design entity objects 404 with corresponding executable instruction set instructions that, in accordance with conventional HDL simulation model processing techniques, result in a pseudo hardware implementation of the object design entities. Furthermore, model build tool 208 includes program instruction means for individually translating each of instrumentation objects 406 into one or more corresponding instruction set instructions. To this end, model build tool 208 is augmented to include object level translations of each of the irreducible intermediate level instrumentation objects.

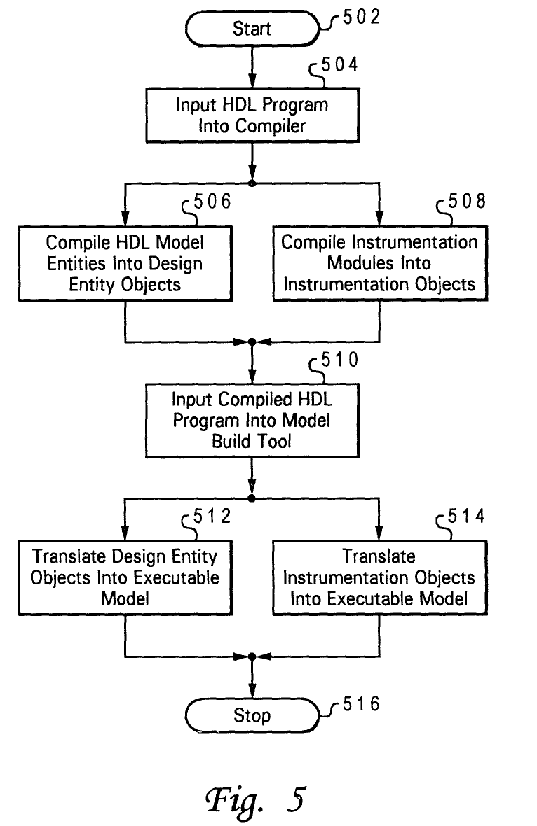

With reference to FIG. 5, there is illustrated a flow diagram depicting process steps performed by the model compilation and assembly system depicted in FIGS. 2 and 4 during instrumentation assimilation in accordance with a preferred embodiment of the present invention. The process begins at step 502 and proceeds to step 504 with HDL source code program 202 being applied as input into compiler 204. During compilation processing of HDL source code program 202, and as depicted at step 506, the HDL design entities Entity1 through EntityN are compiled into multiple design entity objects 404 which, as explained with reference to FIG. 2, express software equivalents of simulated hardware components and devices (latches, gates, pins, etc.). As an additional part of the compilation processing of HDL source code program 202, and as illustrated at step 508, each of instrumentation modules Instr_A and Instr_B are compiled into a single instrumentation object that expresses a simulation analysis function in which simulation data is stored and processed over a simulation testcase.

Following compilation steps 506 and 508, the resultant object code database comprising both the design entity objects and the instrumentation objects is applied as input into model build tool 208 as depicted at step 510. Model build tool 208 then translates each of the irreducible intermediate level design entity objects and each of the instrumentation objects into a set of one or more instruction set instructions as depicted at steps 512 and 514. Model build post-compile processing steps 512 and 514 result in the generation of instrumented executable simulation model 210 and the process terminates as illustrated at step 516.

Preferred implementations of the invention include implementations as a computer system programmed to execute the method or methods described herein, and as a program product. According to the computer system implementation, sets of instructions for executing the method and system of the present invention are resident in a storage device such as the ROM or RAM of computer processing systems within one or more networked nodes. Until required by the computer system, the set of instructions may be stored as a computer-program product in another computer memory, for example, in a disk drive (which may include a removable memory such as an optical disk or floppy disk for eventual utilization in disk drive).

A method and system have been disclosed for implementing simulation analysis instrumentation within an HDL model. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for incorporating simulation analysis instrumentation within an executable hardware description language (HDL) model, said method comprising:
compiling one or more source code HDL design entities into one or more corresponding design entity objects;
compiling one or more source code instrumentation modules into one or more corresponding instrumentation objects, wherein each of the one or more instrumentation objects is a single irreducible intermediate object code primitive that invokes a simulation analysis function in which simulation data is processed over multiple simulation testcase cycles; and
post-compile processing an object code file to relate the one or more design entity objects and the one or more instrumentation objects within an executable simulation model.

2. The method of claim 1, wherein said post-compile processing comprises:
translating each of the one or more design entity objects into executable instruction set instructions that implement the circuit functionality; and
translating each of the one or more instrumentation objects into executable instruction set instructions corresponding to a non-hardware simulated implementation of the simulation analysis function.

3. The method of claim 1, wherein the simulated circuit functionality includes data storage elements and logic gates.

4. The method of claim 1, wherein the simulation analysis function is a statistics compilation function.

5. The method of claim 4, wherein the statistical compilation function is a max function, a min function, or an avg function.

6. The method of claim 1, further comprising:
executing a simulation test program with the executable simulation model as input within a simulation client; and
outputting simulation analysis results generated by the executable instruction set instructions that implement the simulation analysis function on a data output device on the simulation client.

7. A system for incorporating simulation analysis instrumentation within an executable hardware description language (HDL) model, said system comprising:
processing means for compiling at least one source code HDL design entity that simulates circuit functionality within the HDL model into one or more design entity objects;
processing means for compiling one or more source code instrumentation modules into one or more corresponding instrumentation objects, wherein each of the one or more instrumentation objects is a single irreducible intermediate object code primitive that invokes a simulation analysis function in which simulation data is processed over multiple simulation testcase cycles; and
means for post-compile processing an object code file to relate the one or more design entity objects and the one or more instrumentation objects within an executable simulation model.

8. The system of claim 7, wherein said means for post-compile processing comprises:
processing means for translating each of the one or more design entity objects into executable instruction set instructions that implement the circuit functionality; and
processing means for translating each of the one or more instrumentation objects into executable instruction set instructions corresponding to a non-hardware simulated implementation of the simulation analysis function.

9. The system of claim 7, wherein the simulated circuit functionality includes data storage elements and logic gates.

10. The system of claim 7, wherein the simulation analysis function is a statistics compilation function.

11. The system of claim 10, wherein the statistical compilation function is a max function, a min function, or an avg function.

12. The system of claim 7, further comprising:
processing means for executing a simulation test program with the executable simulation model as input within a simulation client; and
processing means for outputting simulation analysis results generated by the executable instruction set instructions that implement the simulation analysis function on a data output device on the simulation client.

13. A program product for incorporating simulation analysis instrumentation within an executable hardware description language (HDL) model, said program product comprising:
instruction means for compiling at least one source code HDL design entity that simulates circuit functionality within the HDL model into one or more design entity objects;
instruction means for compiling one or more source code instrumentation modules into one or more corresponding instrumentation objects, wherein each of the one or more instrumentation objects is a single irreducible intermediate object code primitive that invokes a simulation analysis function in which simulation data is processed over multiple simulation testcase cycles; and
instruction means for post-compile processing an object code file to relate the one or more design entity objects and the one or more instrumentation objects within an executable simulation model.

14. The program product of claim 13, wherein said instruction means for post-compile processing comprises:
instruction means for translating each of the one or more design entity objects into executable instruction set instructions that implement the circuit functionality; and
instruction means for translating each of the one or more instrumentation objects into executable instruction set instructions corresponding to a non-hardware simulated implementation of the simulation analysis function.

15. The program product of claim 13, wherein the simulated circuit functionality includes data storage elements and logic gates.

16. The program product of claim 13, wherein the simulation analysis function is a statistics compilation function.

17. The program product of claim 16, wherein the statistical compilation function is a max function, a min function, or an avg function.

18. The program product of claim 13, further comprising:
instruction means for executing a simulation test program with the executable simulation model as input within a simulation client; and
instruction means for outputting simulation analysis results generated by the executable instruction set instructions that implement the simulation analysis function on a data output device on the simulation client.
